(19) United States
(12) Patent Application Publication
(10) Pub. No.: US 2015/0156389 A1
(43) Pub. Date: Jun. 4, 2015

(54) STROBE DEVICE, PHOTOGRAPHY DEVICE, AND METHOD FOR PROCESSING IMAGE

(71) Applicant: Panasonic Intellectual Property Management Co., Ltd., Osaka (JP)

(72) Inventor: Takashi Umehara, Osaka (JP)

(73) Assignee: Panasonic Intellectual Property Management Co., Ltd., Osaka (JP)

(21) Appl. No.: 14/418,475

(22) PCT Filed: Aug. 19, 2013
(86) PCT No.: PCT/JP2013/004888

§ 371 Date: Jan. 30, 2015

(30) Foreign Application Priority Data
Aug. 20, 2012 (JP) 2012-181483

(51) Int. Cl. H04N 5/235; H04N 9/64

(52) U.S. Cl. CPC H04N 5/2354; H04N 9/646

(57) ABSTRACT

The present invention has a strobe body unit, a light-emitting unit rotatably coupled to a strobe body unit, and a strobe control unit configured to control a light-emitting direction angle of the light-emitting unit and an amount of light from the light-emitting unit. The strobe control unit has a first preliminary light-emitting mode for making the light-emitting unit emit light toward a reflective object; a second preliminary light-emitting mode for making the light-emitting unit emit light toward a subject; and a main light-emitting mode for making the light-emitting unit emit light toward the reflective object with the amount of light greater than any of the first preliminary light-emitting mode and the second preliminary light-emitting mode to irradiate the subject with bounce light reflected from the reflective object. With that configuration, a strobe device, an imaging apparatus, and an image processing method configured to obtain a desired image are realized.

### TECHNICAL FIELD

The present invention relates to a strobe device that has a light-emitting unit rotatably coupled to a strobe body unit, an imaging apparatus, and an image processing method.

### BACKGROUND ART

Conventionally, for the purpose of obtaining more natural photographs, imaging apparatuses have been configured to use bounce photography which is a technique of capturing an image by causing a light-emitting unit of a strobe device to emit light toward a reflective object such as a ceiling or a wall to diffuse the light so that a subject is indirectly irradiated with the diffused light.

Specifically, the bounce photography is a technique of capturing a subject image not by directing a light-emitting surface of the light-emitting unit of the strobe device toward the subject but by directing the light-emitting surface in a desired direction toward the reflective object such as a ceiling or a wall to cause the light emitted from the strobe device to be reflected from the reflective object and to illuminate the subject.

Then, there has been proposed a configuration of a conventional strobe device to automatically control a bounce emitting light angle formed between an image-capturing direction which is an optical axis direction of an imaging lens and a light-emitting direction in which the strobe device flashes light (a desired direction toward the reflective object) by using a strobe control unit of the strobe device (see, for example, PL1). It is described in PL1 that the strobe device with the above described configuration can indirectly illuminate the subject by always directing the light-emitting unit toward a reflective object and emitting light to the reflective object.

In addition, the strobe device described in PL1 measures the distance with autofocus by directing the imaging lens of the imaging apparatus toward the reflective object and the subject respectively and sets the bounce emitting light angle based on the directions from the reflective object and the subject and photographs the subject.

In that case, on the condition that the strobe device captures an image of the subject that is irradiated with light reflected from a reflective object in white or the like, for example, the captured image does not have any problem in particular.

However, on the condition that the strobe device captures an image of the subject that is irradiated with bounce light reflected from a reflective object that is colored (for example, red or blue), the captured image is affected by the color and the like of the reflective object. In other words, although the strobe device illuminates the subject by bounce light which is originally white, the resulting bounce light is contaminated with the color of the reflective object. For example, in the case where the ceiling as the reflective object is red, the image is captured in a screen that is reddish as a whole.

### CITATION LIST

### Patent Literature

PTL1: Unexamined Japanese Patent Publication No. 2009-163179

### SUMMARY OF THE INVENTION

In order to solve the above described problem, the strobe device according to the present invention has a strobe body unit, a light-emitting unit rotatably coupled to the strobe body unit, and a strobe control unit configured to control a light-emitting direction angle of the light-emitting unit and an amount of light from the light-emitting unit. The strobe control unit has a first preliminary light-emitting mode for making the light-emitting unit emit light toward a reflective object; a second preliminary light-emitting mode for making the light-emitting unit emit light toward a subject; and a main light-emitting mode for making the light-emitting unit emit light toward the reflective object with the amount of light greater than any of preliminary light-emitting mode and the second preliminary light-emitting mode to irradiate the subject with bounce light reflected from the reflective object.

With that configuration, the light-emitting unit is controlled in the first preliminary light-emitting mode to emit light toward the reflective object. In addition, the light-emitting unit is controlled in the second preliminary light-emitting mode to emit light toward the subject. Further, the light-emitting unit is controlled in the main light-emitting mode to emit light toward the reflective object with the amount of light greater than the amount of light in the first preliminary light-emitting mode and the amount of light in the second preliminary light-emitting mode to irradiate the subject with bounce light reflected from the reflective object.

Then, both of a first preliminary image which has been captured when the light-emitting unit is caused to emit light in the first preliminary light-emitting mode and a second preliminary image which has been captured when the light-emitting unit is caused to emit light in the second preliminary light-emitting mode, for example, are differenced and a difference image is formed. A main image which is captured when the light-emitting unit is caused to emit light in the main light-emitting mode is processed based on the formed difference image. As a result, an image that has influences of a color and the like of the reflective object eliminated or an image that has influences of a color and the like of the reflective object reduced can be obtained.

In addition, the imaging apparatus according to the present invention has the above described strobe device; an imaging unit configured to capture an image of the subject; and an image processing unit configured to process the image captured by the imaging unit. The imaging unit is configured to cause the light-emitting unit to emit light in a first preliminary light-emitting mode, a second preliminary light-emitting mode, and a main light-emitting mode to capture the image of the subject in each of the modes. The image processing unit processes the main image captured with the light-emitting unit emitted light in the main light-emitting mode based on difference image obtained by differencing a first preliminary image and a second preliminary image captured respectively with the light-emitting unit emitted light in the first preliminary light-emitting mode and the second preliminary light-emitting mode.

With that configuration, the light-emitting unit is caused to emit light in the first preliminary light-emitting mode, the second preliminary light-emitting mode, and the main light-emitting mode, and the image of the subject is captured by the imaging unit in each of the modes. Then, the image processing unit processes the main image which is captured when the light-emitting unit is caused to emit light in the main light-emitting mode based on the difference image obtained by differencing the first preliminary image which has been captured when the light-emitting unit is caused to emit light in the first preliminary light-emitting mode and the second preliminary image which has been captured when the light-emitting unit is caused to emit light in the second preliminary light-emitting mode. As a result, an image that has no influences of a color and the like of the reflective object or an image that has reduced influences of a color and the like of the reflective object can be obtained. It should be noted that the term “image” in the present invention is a concept that implicates not only a mere image but also image data.

Further, the present invention is an image processing method for processing an image captured with the strobe device. The image processing method includes the steps of: capturing an image of the subject by causing the light-emitting unit to emit light in the first preliminary light-emitting mode; capturing an image of the subject by causing the light-emitting unit to emit light in the second preliminary light-emitting mode; and capturing an image of the subject by causing the light-emitting unit to emit light in the main light-emitting mode. The image processing method further includes the steps of: producing a difference image by differencing the first preliminary image and the second preliminary image captured respectively with the light-emitting unit emitted light in the first preliminary light-emitting mode and the second preliminary light-emitting mode; and processing the main image captured with the light-emitting unit emitted light in the main light-emitting mode, based on the difference image.

According to the image processing method, first, the imaging apparatus obtains the first preliminary image by capturing an image of the subject while causing the light-emitting unit to emit light in the first preliminary light-emitting mode. Next, the imaging apparatus obtains the second preliminary image by capturing an image of the subject while causing the light-emitting unit to emit light in the second preliminary light-emitting mode. Then, the imaging apparatus obtains the main image by capturing an image of the subject while causing the light-emitting unit to emit light in the main light-emitting mode. Then, the imaging apparatus produces a difference image by differencing both of the first preliminary image which has been captured while causing the light-emitting unit to emit light in the first preliminary light-emitting mode and the second preliminary image which has been captured while causing the light-emitting unit to emit light in the second preliminary light-emitting mode. Based on the produced difference image, the imaging apparatus processes the main image which the imaging apparatus has been captured while having caused the light-emitting unit to emit light in the main light-emitting mode. As a result, the imaging apparatus can obtain an image that has no influence of a color and the like of the reflective object or an image that has reduced influences of a color and the like of the reflective object.

### BRIEF DESCRIPTION OF DRAWINGS

FIG. 1 is a block diagram illustrating a configuration of an imaging apparatus according to an exemplary embodiment of the present invention.

FIG. 2 is a front view of a strobe device according to the exemplary embodiment.

FIG. 3 is a plan view of the strobe device according to the exemplary embodiment.

FIG. 4 is a diagram illustrating an up and down irradiation range (a vertical irradiation range) that can be set to the strobe device according to the exemplary embodiment.

FIG. 5 is a diagram illustrating a left and right irradiation range (a horizontal irradiation range) that can be set to the strobe device according to the exemplary embodiment.

FIG. 6 is a flow chart of an image processing method according to the exemplary embodiment.

FIG. 7 is a diagram for describing the image processing method according to the exemplary embodiment.

### DESCRIPTION OF EMBODIMENT

The strobe device according to an exemplary embodiment of the present invention and the imaging apparatus provided with the strobe device will be described with reference to the drawings. It should be noted that the exemplary embodiment below is an example that embodies the present invention and does not limit a technical scope of the present invention.

### Exemplary Embodiment

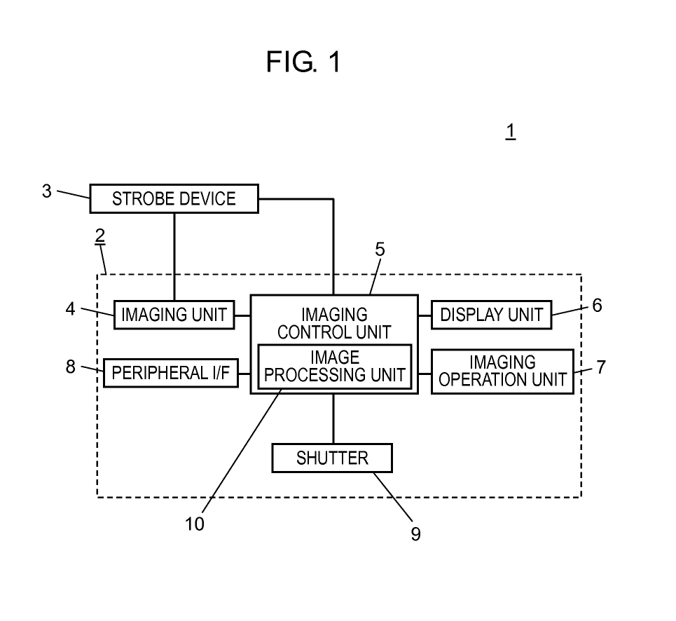

The strobe device according to the exemplary embodiment of the present invention and the imaging apparatus provided with the strobe device will be described below with reference to FIG. 1 to FIG. 5.

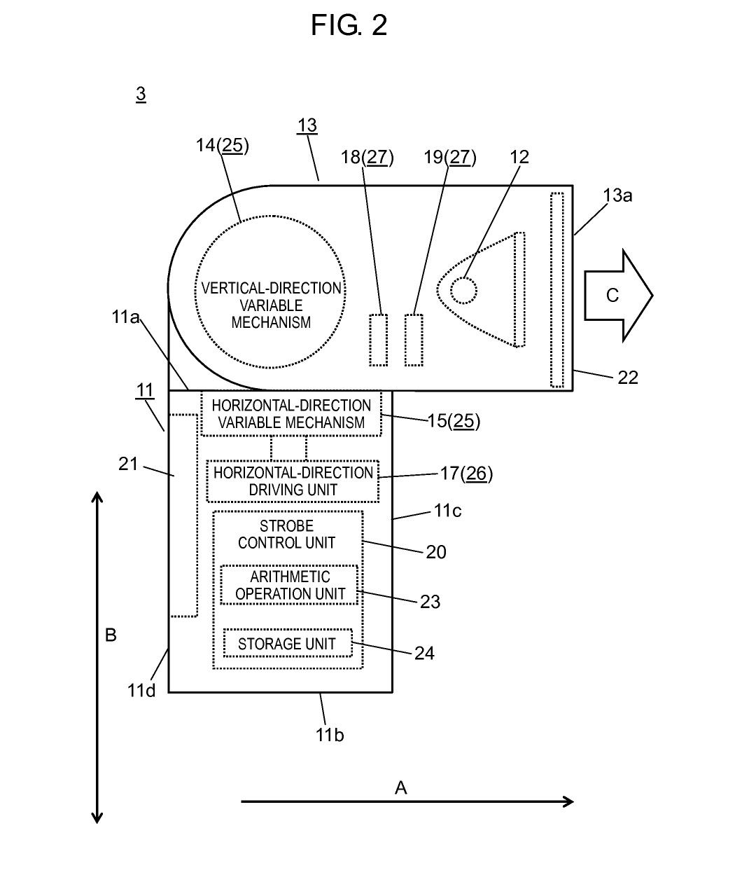

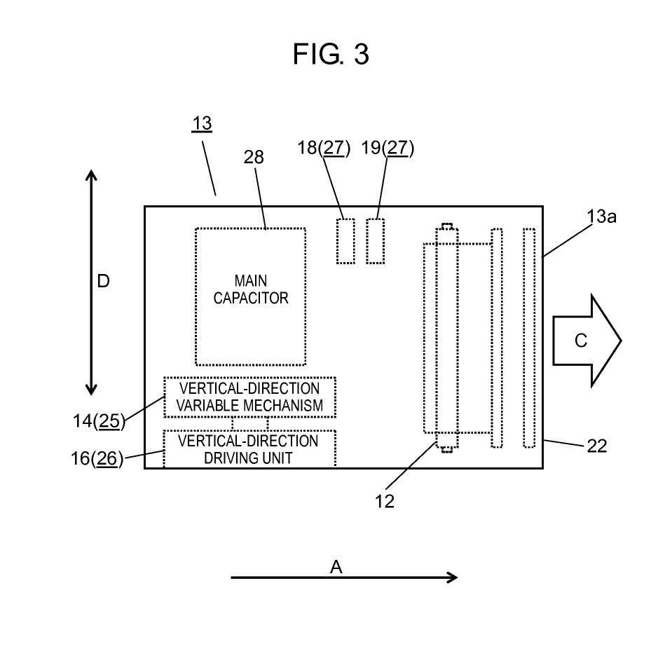

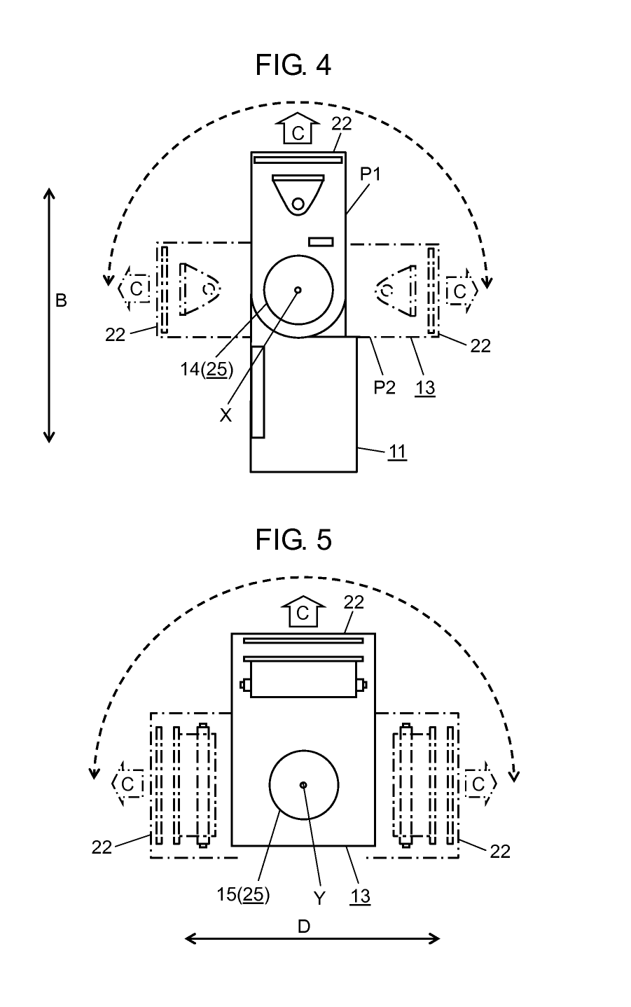

FIG. 1 is a block diagram illustrating a configuration of an imaging apparatus according to the exemplary embodiment of the present invention. FIG. 2 is a front view of a strobe device according to the exemplary embodiment. FIG. 3 is a plan view of the strobe device according to the exemplary embodiment. FIG. 4 is a diagram illustrating an up and down irradiation range (a vertical irradiation range) that can be set to the strobe device according to the exemplary embodiment. FIG. 5 is a diagram illustrating a left and right irradiation range (a horizontal irradiation range) that can be set to the strobe device according to the exemplary embodiment.

As illustrated in FIG. 1, imaging apparatus 1 of the exemplary embodiment includes imaging apparatus body 2 and strobe device 3. Strobe device 3 is mountable to imaging apparatus body 2 and is configured to project strobe light toward a subject or a reflective object.

Imaging apparatus body 2 includes imaging unit 4 configured to image a subject, imaging control unit 5, display unit 6, imaging operation unit 7, peripheral interface 8 (peripheral I/F 8), and shutter 9. Imaging control unit 5 controls strobe device 3 and imaging unit 4. Further, imaging control unit 5 includes image processing unit 10 which is configured to process an image captured by imaging unit 4. Display unit 6 is configured to display a captured subject image and the like. Imaging operation unit 7 switches setting items of imaging conditions and on-off of a power supply. Peripheral interface 8 is configured to input and output image data and the like between imaging apparatus 1 and a peripheral device. Shutter 9 is operated by a user who wants to use strobe device 3 to image a subject.

In addition, as illustrated in FIG. 2 and FIG. 3, strobe device 3 includes at least strobe body unit 11 which is made of, for example, a rectangular housing, light-emitting unit 13, variable mechanism 25, driving unit 26, angle detection unit 27, strobe control unit 20, and strobe operation unit 21. Light-emitting unit 13 is rotatably coupled to strobe body unit 11 and houses flash discharge tube 12. Then, light-emitting unit 13 causes flash discharge tube 12 to emit light by using, for example, electric energy supplied from main capacitor 28 and radiates the emitted light to outside. Variable mechanism 25 allows light-emitting unit 13 to move at a predetermined angle. Driving unit 26 drives variable mechanism 25. Angle detection unit 27 detects an angle of light-emitting unit 13 with respect to strobe body unit 11. Strobe control unit 20 controls strobe device 3. Strobe operation unit 21 is provided on, for example, back side 11d of strobe body unit 11 and performs such operations as input of various set values and selection of various modes.

In addition, light-emitting unit 13 is rotatably coupled to top side 11a of strobe body unit 11. Further, imaging apparatus body 2 illustrated in FIG. 1 is connectably provided on bottom side 11b of strobe body unit 11. In that case, strobe body unit 11 is coupled to imaging apparatus body 2 so that front 11c of strobe body unit 11 faces in imaging direction A (an optical axis direction of an imaging lens) of imaging apparatus 1.

In addition, light-emitting unit 13 is made of, for example, a substantially rectangular housing or a rectangular housing, with one surface 13a of the housing provided with opening portion 22 for radiating the light emitted from flash discharge tube 12. Further, light-emitting unit 13 is configured to allow irradiating direction C for emitting strobe light to be changed in response to change in inclination angle of opening portion 22 in vertical direction B.

In addition, variable mechanism 25 includes vertical-direction variable mechanism 14 and horizontal-direction variable mechanism 15 as illustrated in FIG. 4 and FIG. 5 and rotatably couples strobe body unit 11 and light-emitting unit 13. Specifically, vertical-direction variable mechanism 14 of variable mechanism 25 is coupled to strobe body unit 11 so that vertical-direction variable mechanism 14 is able to rotate in vertical direction B on horizontal shaft X illustrated in FIG. 4 which is provided in strobe body unit 11 in horizontal direction D (see, FIG. 3). On the other hand, horizontal-direction variable mechanism 15 of variable mechanism 25 is coupled to strobe body unit 11 so that horizontal-direction variable mechanism 15 is able to rotate in horizontal direction D on vertical shaft Y (see, FIG. 5) which is provided in strobe body unit 11 in vertical direction B.

Further, as illustrated in FIG. 4, vertical-direction variable mechanism 14 of variable mechanism 25 is configured to be able to change an angle of light-emitting unit 13 in vertical direction B. Specifically, in the exemplary embodiment, vertical-direction variable mechanism 14 rotates within 180 degrees which is a range of rotating angle in vertical direction B.

On the other hand, as illustrated in FIG. 5, horizontal-direction variable mechanism 15 of variable mechanism 25 is configured to be able to change an angle of light-emitting unit 13 in horizontal direction D. Then, in the exemplary embodiment, horizontal-direction variable mechanism 15 has a rotating angle of 180 degrees in horizontal direction D.

In addition, as illustrated in FIG. 2 and FIG. 3, driving unit 26 is provided with vertical-direction driving unit 16 (see, FIG. 3) which is made of, for example, a vertical-direction driving motor and the like and configured to rotate vertical-direction variable mechanism 14, and also provided with horizontal-direction driving unit 17 (see, FIG. 2) which is made of, for example, a horizontal-direction driving motor and the like and configured to rotate horizontal-direction variable mechanism 15.

In addition, angle detection unit 27 is provided on light-emitting unit 13 and includes vertical-direction angle detection unit 18 which is configured to detect an angle of light-emitting unit 13 in vertical direction B and horizontal-direction angle detection unit 19 which is configured to detect an angle of light-emitting unit 13 in horizontal direction D.

In this case, in the exemplary embodiment, vertical-direction angle detection unit 18 is made of, for example, three axes acceleration sensor which is configured to detect acceleration in three directions of the x-axis, the y-axis, and the z-axis. The three axes acceleration sensor is configured to detect an inclination angle of light-emitting unit 13 (an orientation of light-emitting unit 13) in vertical direction B of light-emitting unit 13 by detecting gravitational acceleration of light-emitting unit 13 which is at rest. In the exemplary embodiment, horizontal-direction angle detection unit 19 is made of a magnetic field sensor which is configured to detect the strength and the direction of a magnetic field (or a field). Horizontal-direction angle detection unit 19 is configured to detect an inclination angle of light-emitting unit 13 (an orientation of light-emitting unit 13) in horizontal direction D of light-emitting unit 13 by detecting the compass direction which light-emitting unit 13 faces.

In addition, strobe control unit 20 is provided with arithmetic operation unit 23 which is configured to perform various kinds of arithmetic processing and storage unit 24 which is configured to store various types of information. Strobe control unit 20 is made of a CPU, and storage unit 24 is made of a built-in RAM or a built-in ROM of the CPU or a RAM or ROM externally connected to the CPU.

Then, storage unit 24 of strobe control unit 20 stores a plurality of light-emitting modes for controlling light-emitting unit 13 described later. Specifically, storage unit 24 of strobe control unit 20 stores a plurality of modes, for example, a first preliminary light-emitting mode, a second preliminary light-emitting mode, and a main light-emitting mode, which are for controlling a light-emitting direction angle of light-emitting unit 13 and the amount of light-emitting unit 13. The first preliminary light-emitting mode is a mode in which light-emitting unit 13 emits light toward the reflective object. The second preliminary light-emitting mode is a mode in which light-emitting unit 13 emits light toward the subject. The main light-emitting mode is a mode for causing light-emitting unit 13 to emit light toward the reflective object with the amount of light greater than the amount of light in the first preliminary light-emitting mode and the amount of light in the second preliminary light-emitting mode to irradiate the subject with bounce light reflected from the reflective object.

In addition, as illustrated in FIG. 1, imaging control unit 5 provided on imaging apparatus body 2 is configured to instruct strobe control unit 20 to control light-emitting unit 13 to emit light and is also configured to control imaging unit 4. Imaging unit 4 under the control of imaging control unit 5 captures the image of the subject in accordance with each of the modes when imaging control unit 5 causes the light-emitting unit to emit light in the first preliminary light-emitting mode, the second preliminary light-emitting mode, and the main light-emitting mode.

In addition, image processing unit 10 provided on imaging control unit 5 is configured to produce a difference image by performing a difference process on both of the image in the first preliminary light-emitting mode and the image in the second preliminary light-emitting mode both of which have been captured by imaging unit 4 when light-emitting unit 13 is caused to emit light in the first preliminary light-emitting mode and the second preliminary light-emitting mode. Image processing unit 10 is configured to subsequently process the image captured by imaging unit 4, which has caused light-emitting unit 13 to emit light in the main light-emitting mode, based on the difference image obtained by the difference process. As a result, an image that has no influence of a color and the like of the reflective object or an image that has reduced influences of a color and the like of the reflective object can be obtained.

With the above described configuration, strobe device 3 and imaging apparatus 1 according to the present exemplary embodiment are configured.

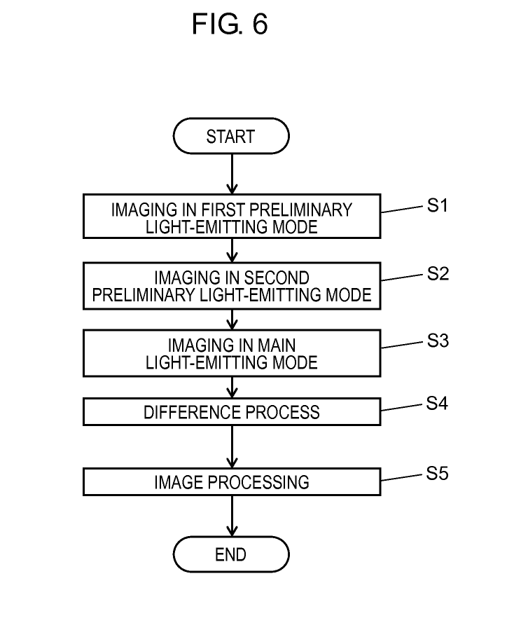

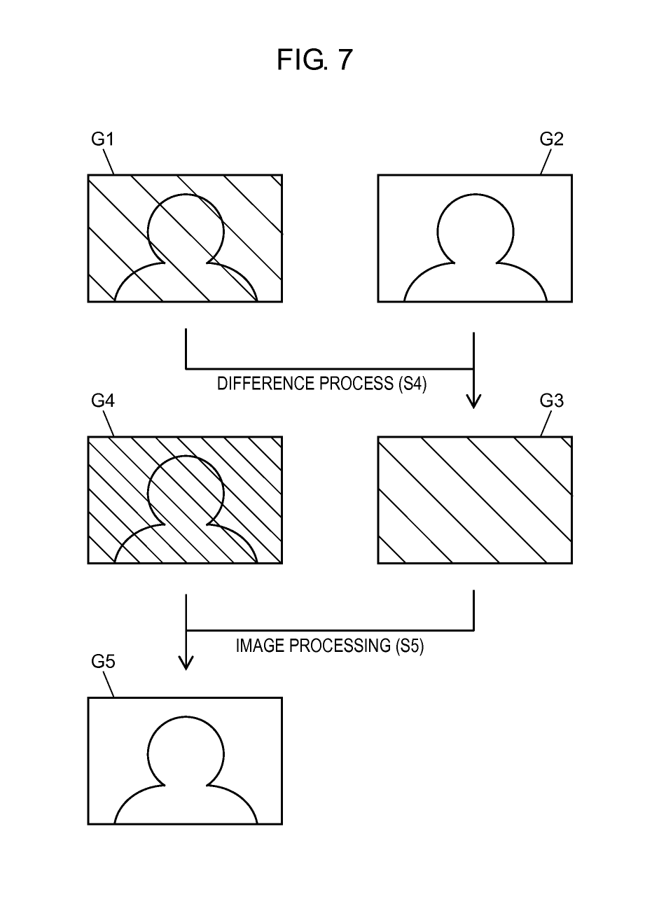

An image processing method that uses strobe device 3 and imaging apparatus 1 according to the present exemplary embodiment will be described below using FIG. 6 and FIG. 7 with reference to FIG. 1, FIG. 2, and FIG. 4. In the present exemplary embodiment, the method will be described by using an example of imaging apparatus 1 that automatically performs each of imaging processes or image processing in response to a single pressing event on shutter 9.

FIG. 6 is a flow chart of the image processing method according to the present exemplary embodiment. FIG. 7 is a diagram for describing the image processing method according to the present exemplary embodiment.

First, a photographer directs the imaging lens of imaging apparatus 1 illustrated in FIG. 1 at a subject and presses shutter 9.

As a result, as shown in FIG. 6, strobe control unit 20 of strobe body unit 11 controls light-emitting unit 13 to emit light in the first preliminary light-emitting mode based on the instruction from imaging control unit 5 of imaging apparatus body 2. Then, strobe control unit 20 controls light-emitting unit 13 to emit light toward a reflective object and, concurrently, imaging control unit 5 controls imaging unit 4 to capture an image of the subject in the first preliminary light-emitting mode and obtains first preliminary image G1 illustrated in FIG. 7 (step S1). At that moment, the orientation of light-emitting unit 13 in the first preliminary light-emitting mode is an upward orientation. Specifically, that orientation which corresponds to P1 illustrated in FIG. 4 is an orientation in which light-emitting unit 13 forms 90 degrees upward in vertical direction B with respect to strobe body unit 11.

Next, strobe control unit 20 of strobe body unit 11 controls light-emitting unit 13 to emit light in the second preliminary light-emitting mode. Then, strobe control unit 20 controls light-emitting unit 13 to emit light toward the subject and, concurrently, imaging control unit 5 controls imaging unit 4 to capture an image of the subject in the second preliminary light-emitting mode and obtains second preliminary image G2 illustrated in FIG. 7 (step S2). At that moment, the orientation of light-emitting unit 13 in the second preliminary light-emitting mode is an orientation facing the subject. Specifically, that orientation, which corresponds to P2 illustrated in FIG. 4, is an orientation in which light-emitting unit 13 directly irradiates the subject with strobe light.

Next, strobe control unit 20 of strobe body unit 11 controls light-emitting unit 13 to emit light in the main light-emitting mode. At that moment, in the main light-emitting mode, strobe control unit 20 causes light-emitting unit 13 to emit light toward the reflective object with the amount of light greater than the amount of light in the first preliminary light-emitting mode and the amount of light in the second preliminary light-emitting mode. As a result, strobe control unit 20 makes bounce light reflected from the reflective object irradiate the subject, and, concurrently, imaging control unit 5 controls imaging unit 4 to capture an image of the subject in the main light-emitting mode and obtains main image G4 illustrated in FIG. 7 (step S3). At that moment, light-emitting unit 13 faces obliquely upward. Specifically, light-emitting unit 13 faces at an angle, for example, between P1 and P2 illustrated in FIG. 4.

Next, image processing unit 10 of imaging control unit 5 performs difference process on the image captured in the first preliminary light-emitting mode and the image captured in the second preliminary light-emitting mode (step S4). Specifically, as illustrated in FIG. 7, image processing unit 10 performs difference process on first preliminary image G1 which has been captured by imaging unit 4 while light-emitting unit 13 has been caused to emit light in the first preliminary light-emitting mode and second preliminary image G2 which has been captured by imaging unit 4 while light-emitting unit 13 has been caused to emit light in the second preliminary light-emitting mode (step S4). As a result, difference image G3, illustrated in FIG. 7, in which the subject and the like have been removed is obtained.

Next, image processing unit 10 of imaging control unit 5 processes main image G4, which has been captured by imaging unit 4 while light-emitting unit 13 has been caused to emit light in the main light-emitting mode, based on difference image G3 obtained by the difference process (step S5). As a result, processed image G5 that has no influence of a color and the like of the reflective object or an image that has reduced influences of a color and the like of the reflective object is obtained. Meanwhile, usually, the amounts of light emitted from light-emitting unit 13 differ in the first preliminary light-emitting mode, the second preliminary light-emitting mode, and the main light-emitting mode. Then, image processing unit 10 performs predetermined arithmetic operations such as exposure correction on difference image G3 illustrated in FIG. 7, for example, and subsequently performs a difference process on difference image G3 after the correction and main image G4. As a result, image processing unit 10 can obtain desired processed image G5.

It should be noted that the example in which image processing unit 10 of imaging control unit 5 obtains processed image G5 by performing difference process on main image G4 has been described above, but the present invention is not limited to that. For example, processed image G5 may be obtained as a result of recording difference image G3 and main image G4 illustrated in FIG. 7 in a personal computer via an electronic storage unit medium and performing the difference process on difference image G3 and main image G4 by using the personal computer. In that manner, imaging apparatus 1 can improve processability and versatility.

As described above, according to strobe device 3 and imaging apparatus 1 according to the present exemplary embodiment, first, light-emitting unit 13 is controlled in the first preliminary light-emitting mode and emits light toward the reflective object. Next, light-emitting unit 13 is controlled in the second preliminary light-emitting mode and emits light toward the subject. Then, light-emitting unit 13 is controlled in the main light-emitting mode and emits light toward the reflective object with the amount of light greater than the amount of light in the first preliminary light-emitting mode and the amount of light in the second preliminary light-emitting mode. As a result, light-emitting unit 13 irradiates the subject with bounce light reflected from the reflective object.

Next, while light-emitting unit 13 is caused to emit light in the first preliminary light-emitting mode, the second preliminary light-emitting mode, and the main light-emitting mode, imaging unit 4 captures images of the subject which is irradiated correspondingly to the respective modes.

Then, image processing unit 10 obtains difference image G3 by performing the difference process on first preliminary image G1 which has been captured while light-emitting unit 13 is caused to emit light in the first preliminary light-emitting mode and first preliminary image G2 which has been captured while light-emitting unit 13 is caused to emit light in the second preliminary light-emitting mode.

Then, image processing unit 10 obtains processed image G5 by processing main image G4 captured by causing image processing unit 10 to emit light in the main light-emitting mode, based on the obtained difference image G3. As a result, image processing unit 10 can obtain processed image G5 that has no influence of a color and the like of the reflective object or processed image G5 that has reduced influences of a color and the like of the reflective object.

However, in the present exemplary embodiment, in the case where a time period from a start of imaging to a finish of imaging (a time required from the first preliminary light-emitting mode to the main light-emitting mode) is getting long, the condition of the subject may change as a result of movement and the like of the subject. Therefore, the time required is preferably within, for example, one second. In that case, a time taken for changing the orientation of light-emitting unit 13 occupies a large proportion of the time required. In other words, imaging apparatus 1 is able to shorten the time required on the condition that imaging apparatus 1 shortens the time taken for changing the orientation of light-emitting unit 13.

Then, in the present exemplary embodiment, driving unit 26 drives variable mechanism 25 so that light-emitting unit 13, for example, rotates within 2/3π[rad/s]. As a result, imaging apparatus 1 can capture an image of the subject without being influenced by the condition of the subject. It is needless to say that one second is merely an example and the present invention is not limited to that. Also, a rotation range of light-emitting unit 13 is based on an assumption that the reflective object is a ceiling and, accordingly, an amount of change in the angle of light-emitting unit 13 is considered to be around 120° (2/3π[rad/s]) in most cases, but the present invention is not limited to that.

It is needless to say that the strobe device, the imaging apparatus, and the image processing method according to the present exemplary embodiment are not limited to the above described exemplary embodiment and may be subjected to various changes without departing from the spirit of the present invention. Further, it is needless to say that a configuration and a method may be selected from the configurations and the methods according to the various modifications below and adopted as the configuration and the method according to the above described exemplary embodiment.

In other words, although a method for image processing unit 10 of imaging apparatus 1 to perform the difference process and the image processing has been described above in the image processing method according to the present exemplary embodiment, but the present invention is not limited to that. For example, while imaging apparatus 1 causes the light-emitting unit 13 to emit light in the first preliminary light-emitting mode, the second preliminary light-emitting mode, and the main light-emitting mode, imaging apparatus 1 captures images of the subject by imaging unit 4 in accordance with the respective modes. Then, based on respective images such as the first preliminary image which has been captured in the first preliminary light-emitting mode, the second preliminary image which has been captured in the second preliminary light-emitting mode, and the main image which has been captured in the main light-emitting mode, the difference process and the image processing may be performed in another processing apparatus such as a personal computer.

### INDUSTRIAL APPLICABILITY

The strobe device, the imaging apparatus, and the image processing method according to the present invention can be applied to applications that require obtaining a desired image by eliminating influences of a color and the like of the reflective object.

### REFERENCE MARKS IN THE DRAWINGS

1 imaging apparatus
2 imaging apparatus body
3 strobe device
4 imaging unit
5 imaging control unit
6 display unit
7 imaging operation unit
8 peripheral interface (peripheral I/F)
9 shutter
10 image processing unit
11 strobe body unit
11a top side
11b bottom side
11c front
11d back side
12 flash discharge tube
13 light-emitting unit
13a surface
14 vertical-direction variable mechanism
15 horizontal-direction variable mechanism
16 vertical-direction driving unit
17 horizontal-direction driving unit
18 vertical-direction angle detection unit
19 horizontal-direction angle detection unit
20 strobe control unit
21 strobe operation unit
22 opening portion
23 arithmetic operation unit
24 storage unit
25 variable mechanism
26 driving unit
27 angle detection unit
28 main capacitor

1. A strobe device comprising:
a strobe body unit;
a light-emitting unit rotatably coupled to the strobe body unit; and
a strobe control unit configured to control a light-emitting direction angle of the light-emitting unit and an amount of light from the light-emitting unit,
wherein the strobe control unit has a first preliminary light-emitting mode for making the light-emitting unit emit light toward a reflective object; a second preliminary light-emitting mode for making the light-emitting unit emit light toward a subject; and a main light-emitting mode for making the light-emitting unit emit light toward the reflective object with an amount of light greater than any of the first preliminary light-emitting mode and the second preliminary light-emitting mode to irradiate the subject with bounce light reflected from the reflective object.

2. An imaging apparatus comprising:
the strobe device according to claim 1;
an imaging unit configured to capture an image of a subject; and
an image processing unit configured to process the image captured by the imaging unit,
wherein the imaging unit is configured to cause a light-emitting unit to emit light in a first preliminary light-emitting mode, a second preliminary light-emitting mode, and a main light-emitting mode to capture an image of the subject in each of the modes, and
the image processing unit processes a main image captured with the light-emitting unit emitted light in the main light-emitting mode based on a difference image obtained by differencing a first preliminary image and a second preliminary image captured respectively with the light-emitting unit emitted light in the first preliminary light-emitting mode and the second preliminary light-emitting mode.

3. An image processing method for processing an image captured with the strobe device according to claim 1 comprising the steps of:
capturing an image of the subject by causing the light-emitting unit to emit light in the first preliminary light-emitting mode;
capturing an image of the subject by causing the light-emitting unit to emit light in the second preliminary light-emitting mode;
capturing an image of the subject by causing the light-emitting unit to emit light in the main light-emitting mode;
producing a difference image by differencing a first preliminary image and a second preliminary image captured respectively with the light-emitting unit emitted light in the first preliminary light-emitting mode and the second preliminary light-emitting mode; and
processing a main image captured with the light-emitting unit emitted light in the main light-emitting mode, based on the difference image.
